(19) United States
(12) Patent Application Publication
(10) Pub. No.: US 2026/0249333 A1
(43) Pub. Date: Aug. 27, 2026

(54) METHODS AND SYSTEMS FOR CONTROLLING IRON OCHRE PROLIFERATION IN A CONDUIT

(71) Applicant: SOLENO INC., St-Jean-sur-Richelieu (CA)

(72) Inventors: Carl TARINI, St-Joseph-de-Coleraine (CA); Carl DIEZ, Longueuil (CA); David HAMEL, Saint-Ferdinand (CA); Moranne BELIVEAU, St-Jean-sur-Richelieu (CA)

(21) Appl. No.: 19/163,571

(22) PCT Filed: Mar. 7, 2024
(86) PCT No.: PCT/CA2024/050279

§ 371 Date: Sep. 9, 2025

Related U.S. Application Data
(60) Provisional application No. 63/451,091, filed on Mar. 9, 2023.

(51) Int. Cl. B08B 17/00; F16L 1/028; F16L 58/00

(52) U.S. Cl. CPC B08B 17/00; F16L 1/028; F16L 58/00

(57) ABSTRACT

A method for controlling iron ochre proliferation in a conduit comprises mounting a first conductor in proximity of the conduit so that the first conductor is in contact with an environment of the conduit when in use, mounting a second conductor in proximity of the conduit so that the second conductor is in contact with the environment of the conduit without being in direct electrical contact with the first conductor, installing the conduit in the environment if not already present in the environment, and iteratively applying, between the first and second conductors, a voltage having a first polarity and a second polarity opposite from the first polarity. A system for controlling iron ochre proliferation in a conduit comprises the first and second conductors, as well as a voltage source electrically connected to the first and second conductors and configured for iteratively applying the voltage thereon.

### CROSS-REFERENCE

The present application claims priority from U.S. Provisional Patent Application No. 63/451,091, filed on Mar. 9, 2023, the disclosure of which is incorporated by reference herein in its entirety.

### FIELD

The present technology relates to systems and methods of drainage systems. In particular, the present technology introduces systems and methods for controlling iron ochre proliferation in a conduit.

### BACKGROUND

Most houses and commercial buildings have a concrete foundation having, at its base a footing surrounded by a drainage pipe. Typically, the drainage pipe is perforated and surrounded by a gravel bed so that water that may be present in the environment is directed away from the foundation by the drainage pipe. A filter fabric is normally used to prevent dirt from entering the drainage pipe while allowing the passage of water from the environment to the drainage pipe.

Bacteria present in the drainage pipe, for example Gallionella ferruginea, may cause the accumulation of iron ochre, in the form of a thick reddish slime. Iron ochre can potentially lead to clogging and blockage of the drainage pipe, with eventual consequences such as leakage of water from the environment into residential basements. In agricultural settings where drainage pipes may be used, iron ochre may prevent correct drainage of a field.

Known techniques for removing iron ochre from drainage pipes include the use of an ozone treatment, chemicals for killing the bacteria, the use of mechanical techniques such as scrubbing, and the like. Chemicals used for killing the bacteria and not environmentally friendly. Mechanical techniques may cause damage to drainage pipes, particularly when the pipes are made of plastic materials. These techniques are expensive and, although potentially effective, will not prevent later accumulation of iron ochre.

Even though the recent developments identified above may provide benefits, improvements are still desirable.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

### SUMMARY

Embodiments of the present technology have been developed based on developers' appreciation of shortcomings associated with the prior art.

In particular, such shortcomings may comprise (1) the use of harmful chemicals; (2) the potential damage to drainage pipes; and/or (3) the eventual need for later reuse of the conventional solutions.

In one aspect, various implementations of the present technology provide a method for controlling iron ochre proliferation in a conduit, the method comprising: mounting a first conductor in proximity of the conduit so that the first conductor is in contact with an environment of the conduit when in use; mounting a second conductor in proximity of the conduit so that the second conductor is in contact with the environment of the conduit when in use without being in direct electrical contact with the first conductor; installing the conduit in the environment; and iteratively applying, between the first and second conductors, a voltage having a first polarity and a second polarity opposite from the first polarity.

In some embodiments of the present technology, the first and second conductors are attached to the conduit prior to installing the conduit in the environment. In another aspect, various implementations of the present technology provide a method for controlling iron ochre proliferation in a conduit having been installed in an environment, the method comprising: mounting a first conductor in proximity of the conduit so that the first conductor is in contact with the environment of the conduit when in use; mounting a second conductor in proximity of the conduit so that the second conductor is in contact with the environment of the conduit when in use without being in direct electrical contact with the first conductor; and iteratively applying, between the first and second conductors, a voltage having a first polarity and a second polarity opposite from the first polarity.

In some embodiments of the present technology, the method further comprises: drilling an access chimney in the ground, the access chimney reaching the environment of the conduit at a first position; wherein: mounting the first conductor in proximity of the conduit comprises inserting an extremity of the first conductor through the access chimney so that the extremity of the first conductor is guided toward a second position, and mounting the second conductor in proximity of the conduit comprises inserting an extremity of the second conductor through the access chimney so that the extremity of the second conductor is guided toward the second position.

In some embodiments of the present technology, the method further comprises: identifying, within the conduit, a target section in which iron ochre has proliferated; and selecting the first and second positions so that the target section is located between the first and second positions.

In some embodiments of the present technology, the first and second conductors are a first pair of conductors; the access chimney is a first access chimney; the first and second positions are a first pair of positions; and the method further comprises: drilling one or more additional access chimneys reaching the environment at one or more corresponding additional first positions, mounting one or more pairs of additional conductors by inserting extremities of each of the additional conductors through the one or more additional access chimneys so that the extremities of each of the additional conductors are guided toward corresponding additional second positions, and iteratively applying the voltage between opposite conductors of each of the one or more pairs of additional conductors.

In some embodiments of the present technology, the first conductor is connected in parallel with one conductor of each of the one or more pairs of additional conductors; and the second conductor is connected in parallel with an other conductor of each of the one or more pairs of additional conductors.

In some embodiments of the present technology, the first and second conductors are a first pair of conductors; the access chimney is a first access chimney; and the method further comprises: drilling a second access chimney in the ground, the access chimney reaching an underground reservoir fluidly connected to the conduit; mounting a second pair of conductors by inserting extremities of each of the conductors through the second access chimneys so that the extremities of each of the conductors of the second pair reach inside the internal reservoir, and iteratively applying the voltage between opposite conductors of the second pair of conductors.

In some embodiments of the present technology, one or both of the first and second conductors is made of mixed metal oxide titanium.

In some embodiments of the present technology, the environment of the conduit comprises a gravel bed proximate to a building foundation.

In some embodiments of the present technology, the environment of the conduit is within an agricultural field, within a sports field, within an airport runway, or within a playground.

In some embodiments of the present technology, the conduit is perforated and each of the first and second conductors is mounted within the conduit or near an outer surface of the conduit.

In some embodiments of the present technology, the first conductor is inserted within a first tube, the first tube being perforated at regular intervals; the second conductor inserted within a second tube, the second tube being perforated at regular intervals; and the first and second tubes are mounted within the conduit or near an outer surface of the conduit.

In some embodiments of the present technology, the conduit is not perforated and each of the first and second conductors is mounted within the conduit.

In some embodiments of the present technology, the first conductor is inserted within a first tube, the first tube being perforated at regular intervals; the second conductor inserted within a second tube, the second tube being perforated at regular intervals; and the first and second tubes are mounted within the conduit.

In some embodiments of the present technology, the voltage changes between the first and second polarities are a rate of once every 20 minutes or faster.

In some embodiments of the present technology, a magnitude of the voltage is between 7 and 8 volts.

In some embodiments of the present technology, the method further comprises: initially applying the voltage at a first magnitude; and later applying the voltage at a second magnitude different from the first magnitude.

In some embodiments of the present technology, the method further comprises cleaning the conduit from traces of residue.

In some embodiments of the present technology, the conduit is cleaned from the traces of residue at regular intervals.

In some embodiments of the present technology, the voltage is a first voltage, the method further comprising: inserting a first set of rods in the ground in an area surrounding the conduit and the environment; inserting a second set of rods in the ground in proximity of the conduit and of the environment of the conduit; and applying a second voltage between the first set of rods and the second set of rods.

In some embodiments of the present technology, a positive polarity of the second voltage is applied to the first set of rods and a negative polarity of the second voltage is applied to the second set of rods.

In some embodiments of the present technology, the method further comprises iteratively alternating a polarity of the second voltage applied between the first set of rods and the second set of rods.

In some embodiments of the present technology, inserting the first set of rods in the area surrounding the conduit and the environment comprises: inserting each rod of the first set of rods in a respective first stake, and installing each first stake in a vertical position in the ground at a distance of a few meters from the conduit; and inserting the second set of rods in proximity of the conduit and of the environment of the conduit comprises: inserting each rod of the second set of rods in a respective second stake, and installing each second stake in a vertical position in the ground in close proximity to the conduit.

In some embodiments of the present technology, the first and second voltages have substantially the same magnitude. In a further aspect, various implementations of the present technology provide a system for controlling iron ochre proliferation in a conduit, the system comprising: a first conductor configured for being mounted in proximity of the conduit so that the first conductor is in contact with an environment of the conduit when in use; a second conductor configured for being mounted in proximity of the conduit so that the second conductor is in contact with the environment of the conduit when in use without being in direct electrical contact with the first conductor; and a voltage source electrically connected to the first and second conductors and configured for iteratively applying, between the first and second conductors, a voltage having a first polarity and a second polarity opposite from the first polarity.

In some embodiments of the present technology, the system further comprises the conduit.

In some embodiments of the present technology, the first and second conductors are integrally mounted to the conduit.

In some embodiments of the present technology, the conduit is perforated and each of the first and second conductors is configured to be mounted within the conduit or near an outer surface of the conduit.

In some embodiments of the present technology, the first conductor is inserted within a first tube, the first tube being perforated at regular intervals; the second conductor inserted within a second tube, the second tube being perforated at regular intervals; and the first and second tubes are mounted within the conduit or near an outer surface of the conduit.

In some embodiments of the present technology, the conduit is not perforated and each of the first and second conductors is configured to be mounted within the conduit.

In some embodiments of the present technology, the first conductor is inserted within a first tube, the first tube being perforated at regular intervals; the second conductor inserted within a second tube, the second tube being perforated at regular intervals; and the first and second tubes are mounted within the conduit.

In some embodiments of the present technology, the voltage source is configured to change the voltage between the first and second polarities at a rate of once every 20 minutes or faster.

In some embodiments of the present technology, the voltage source is configured to output the voltage at a magnitude between 7 and 8 volts.

In some embodiments of the present technology, the voltage source has a configurable voltage magnitude.

In some embodiments of the present technology, the system further comprises: a pipe configured for forming an access chimney in the ground by installing the pipe in the ground for reaching the environment of the conduit at a first position; wherein: the first conductor is configured to be mounted in proximity of the conduit by inserting an extremity of the first conductor through the access chimney so that the extremity of the first conductor is guided toward a second position, and the second conductor is configured to be mounted in proximity of the conduit by inserting an extremity of the second conductor through the access chimney so that the extremity of the second conductor is guided toward the second position.

In some embodiments of the present technology, the first and second conductors are a first pair of conductors; the pipe is a first pipe; the access chimney is a first access chimney; the first and second positions are a first pair of positions; the system further comprises: one or more additional pipes configured for forming one or more additional access chimneys reaching the environment at one or more corresponding additional first positions, and one or more pairs of additional conductors configured so that extremities of each of the additional conductors are insertable through the one or more additional access chimneys toward one or more additional second positions; wherein the voltage source is configured to iteratively apply the voltage between opposite conductors of each of the one or more pairs of additional conductors.

In some embodiments of the present technology, the first and second conductors are a first pair of conductors; the pipe is a first pipe; the access chimney is a first access chimney; and the system further comprises: a second pipe configured for forming a second access chimney in the ground, the access chimney reaching an underground reservoir fluidly connected to the conduit, and a second pair of conductors configured so that extremities of each of the conductors of the second pair reach inside the internal reservoir; wherein the voltage source is configured to iteratively apply the voltage between opposite conductors of the second pair of conductors.

In some embodiments of the present technology, one or both of the first and second conductors is made of mixed metal oxide titanium.

In some embodiments of the present technology, the environment of the conduit comprises a gravel bed proximate to a building's foundation; and the conduit is a drainage pipe adapted for placement within the gravel bed.

In some embodiments of the present technology, the environment of the conduit is within an agricultural field, within a sports field, within an airport runway, or within a playground; and the conduit is a drainage pipe.

In some embodiments of the present technology, the voltage source comprises: a polarity inverter configured to receive the voltage at the first polarity and to apply the voltage at the first polarity and at the second polarity between the first and second conductors; a controller configured to: receive the voltage and the first polarity from an AC to DC converter, provide the voltage at the first polarity to the polarity inverter, and provide polarity inversion commands to the polarity inverter.

In some embodiments of the present technology, the system further comprises an enclosure containing the polarity inverter and the controller.

In some embodiments of the present technology, the voltage source further comprises: one or more isolation circuits configured to receive the voltage at the first polarity from the AC to DC converter ; and one or more additional polarity inverters, each of the one or more additional polarity inverters being configured to: receive the voltage from a corresponding one of the one or more isolation circuits, receive polarity inversion commands from the controller, and apply the voltage at the first polarity and at the second polarity between a corresponding pair of additional conductors.

In some embodiments of the present technology, the system further comprises the AC to DC converter.

In some embodiments of the present technology, the voltage is a first voltage, the system further comprising: a first set of rods configured for insertion in the ground in an area surrounding the conduit and the environment; and a second set of rods configured for insertion in the ground in proximity of the conduit and of the environment of the conduit; wherein the voltage source is further configured to apply a second voltage between the first set of rods and the second set of rods.

In some embodiments of the present technology, the voltage source is further configured to apply a positive polarity of the second voltage to the first set of rods and to apply a negative polarity of the second voltage to the second set of rods.

In some embodiments of the present technology, the voltage source is further configured to iteratively alternate a polarity of the second voltage applied between the first set of rods and the second set of rods.

In some embodiments of the present technology, each rod of the first set of rods is inserted in a respective first stake configured for vertical insertion in the ground at a distance of a few meters from the conduit; and each rod of the second set of rods is inserted in a respective second stake configured for vertical insertion in the ground in close proximity to the conduit.

In some embodiments of the present technology, the first and second voltages have substantially the same magnitude. In yet another aspect, various implementations of the present technology provide a system for controlling iron ochre proliferation in an inground volume defined by a protected surface, the system comprising: a first set of rods configured for insertion in the ground in an area surrounding the protected surface; and a second set of rods configured for insertion in the ground on a periphery of the protected surface; and a voltage source electrically connected to the first and second sets of rods and configured to apply a voltage between the first set of rods and the second set of rods.

In some embodiments of the present technology, the voltage source is further configured to apply a positive polarity of the voltage to the first set of rods and to apply a negative polarity of the voltage to the second set of rods.

In some embodiments of the present technology, the voltage source is further configured to iteratively alternate a polarity of the voltage applied between the first set of rods and the second set of rods.

In some embodiments of the present technology, each rod of the first set of rods is inserted in a respective first stake configured for vertical insertion in the ground at a distance of a few meters from the protected surface; and each rod of the second set of rods is inserted in a respective second stake configured for vertical insertion in the ground on the periphery of the protected surface.

In some embodiments of the present technology, the protected surface is defined by a periphery of an element selected from a concrete slab, a parking lot, a tennis court, a football field, an airport runway, and an agricultural field.

In some embodiments of the present technology, the system further comprises an additional set of rods, the additional rods being configured for insertion in the ground inside the periphery of the protected surface, the voltage source being further configured to apply a same polarity of the voltage to the second set of rods and to the additional rods.

In the context of the present specification, unless expressly provided otherwise, a controller may refer, but is not limited to, an “electronic device”, an “operation system”, a “system”, a “computer-based system”, a “computer”, a “monitoring device”, a “control device” and/or any combination thereof appropriate to the relevant task at hand.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic top plan view of a foundation of a house with details of a drainage system;

FIG. 2 is a schematic top plan view of the foundation of the house of FIG. 1, also showing a system for controlling iron ochre proliferation in a conduit of the drainage system in accordance with an embodiment of the present technology;

FIGS. 3a, 3b, 3c and 3d are schematic, cross-sectional elevation views of the conduit of the drainage system in its environment in accordance with embodiments of the present technology;

FIG. 4 is a schematic, cross-sectional elevation view of a pair of access chimneys reaching the drainage system in accordance with an embodiment of the present technology;

FIG. 5 is a schematic top plan view of the foundation of the house of FIG. 1, also showing a system for controlling iron ochre proliferation in a target section of the conduit of the drainage system in accordance with an embodiment of the present technology;

FIG. 6 is a schematic, cross-sectional elevation view of a pair of access chimneys, one of which reaches an underground retention reservoir in accordance with an embodiment of the present technology;

FIG. 7 is a schematic perspective view of a field having a drainage system and showing a system for controlling iron ochre proliferation in a conduit of the drainage system in accordance with an embodiment of the present technology;

FIG. 8 is a perspective, cross-sectional view of a cathodic protection system in accordance with an embodiment of the present technology;

FIG. 9 is a sequence diagram showing operations of a method for controlling iron ochre proliferation in a conduit in accordance with an embodiment of the present technology;

FIGS. 10a and 10b are a sequence diagram showing operations of a method for controlling iron ochre proliferation in a conduit having been installed in an environment in accordance with an embodiment of the present technology; and

FIG. 11 is a block diagram of an electronic control system for controlling iron ochre proliferation in a conduit of the drainage system in accordance with an embodiment of the present technology.

It should also be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements that, although not explicitly described or shown herein, nonetheless embody the principles of the present technology.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any sequence diagrams, flowcharts, flow diagrams, state transition diagrams, pseudo-code, and the like represent various processes that may be substantially represented in non-transitory computer-readable media and so executed by a computer or processor, whether or not such computer or processor is explicitly shown.

In an aspect, the present technology uses a pair of conductors installed in the environment of a drainage pipe to inject a low voltage along a length, in whole or in part, of the drainage pipe. A low-level of current is induced in water present in the drainage pipe, effectively killing the bacteria that cause the accumulation of iron ochre. The voltage is applied at a first polarity between the two conductors for a first period of a few minutes, and then at an opposite polarity in a second period, before reverting again to the first polarity. The effect of the application of the voltage between the conductors is essentially limited to the inside of the conduit and, as a result, impacts on the environment outside of the drainage pipe are limited.

The sequential change of polarities causes each of the conductors to sequentially act as an anode and then as a cathode, so that none of the conductors becomes wasted as a so-called “sacrificial anode” and so that calcium precipitation on the cathode is avoided.

With these fundamentals in place, we will now consider some non-limiting examples to illustrate various implementations of aspects of the present technology.

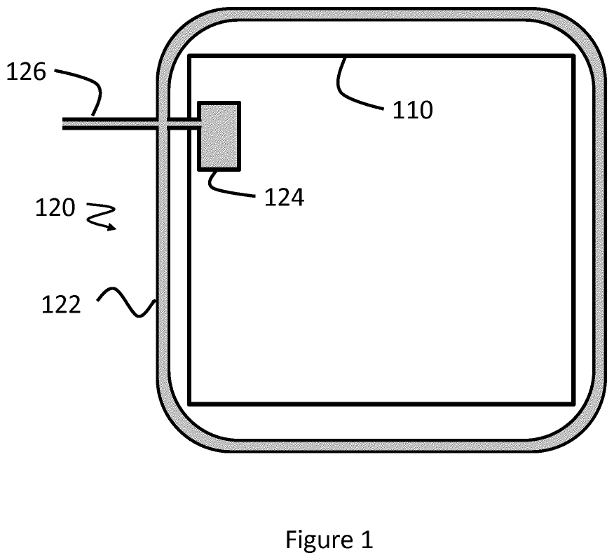

FIG. 1 is a schematic top plan view of a foundation of a house with details of a drainage system. The house 100 (or any commercial or institutional building) has a foundation 110 (only the perimeter thereof is shown in order to simplify the illustration) and a drainage system 120. The drainage system 120 includes a drainage pipe 122 (or an assemblage of interconnected drainage pipes) that surrounds the foundation 110, a sump 124 interconnected with the drainage pipe, and an outlet 126 that connects the drainage system 120 to an external collector (not shown), for example a public sewer main. FIG. 1 is simplified as the foundation 110 may have other shapes, the precise location of the sump 124 and of other components may differ, and the like. The drainage system 120 may be interconnected with a septic system, but will most frequently be independent from the septic system. A pump (not shown) may be installed within the sump 124 and expel on the ground around the house 100 water present in the drainage system 120 when a level of this water raises above a predetermined level.

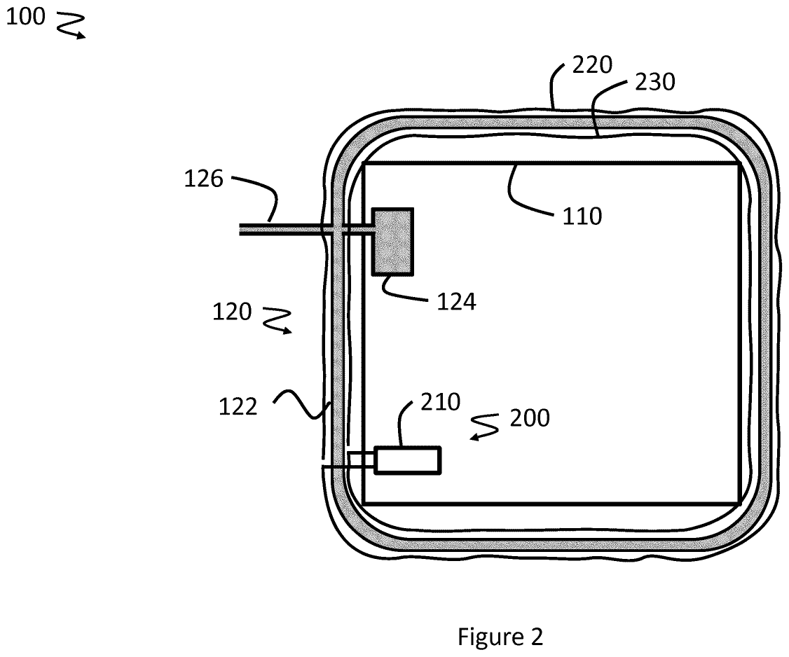

FIG. 2 is a schematic top plan view of the foundation of the house of FIG. 1, also showing a system for controlling iron ochre proliferation in a conduit of the drainage system in accordance with an embodiment of the present technology. The system 200 comprises a voltage source 210 electrically connected to conductors 220 and 230, which are made of a conductive metal material, for example and without limitation, made of titanium covered by precious material oxide, such as mixed metal oxide titanium, for example LIDAR anodes from De Nora S.p.A. of Milan, Italy. The conductors 220 and 230 are mounted in an environment of the drainage pipe 122 and run in parallel along the drainage pipe 122. Both conductors 220 and 230 are electrically connected to respective poles of the voltage source 210. The conductors 220 and 230 are not directly electrically connected to one another at any point; there is not, however, an infinite impedance between the two conductors 220 and 230. In the presence of water in the environment of the drainage pipe 122, a resistance in the order of about 300 ohms is expected to be present between the conductors 220 and 230.

The voltage source 210 applies a voltage, for example 7 or 8 volts, between the conductors 220 and 230. In a first period of up to about 20 seconds, the voltage source 210 applies a negative voltage value at the conductor 220, which is therefore acting as an anode while applying a positive voltage value at the conductor 230, which is therefore acting as a cathode. At this end of the first period, the voltage source 210 inverses the polarities applied on the conductors 220 and 230, so that the conductor 220 becomes a cathode while the conductor 230 becomes an anode. The sequence is repeated continuously. In this context, the terms “positive voltage” and “negative voltage” are relative terms as, for example, one of the voltages may be equal to 0 volt (i.e., ground mass), the other voltage being greater than or less than 0 volt. It is the potential difference applied between the conductors 220 and 230 that matters, as this voltage generate an electrical field that induces a small current within the water, if present in the environment of the drainage pipe 122. The induced current is expected to kill bacteria that may be present in the drainage pipe 122, effectively preventing the occurrence of iron ochre within the drainage pipe 122. If iron ochre is already present in the drainage pipe 122, the iron ochre is expected to gradually dissolve and leave the drainage pipe 122, which becomes unclogged.

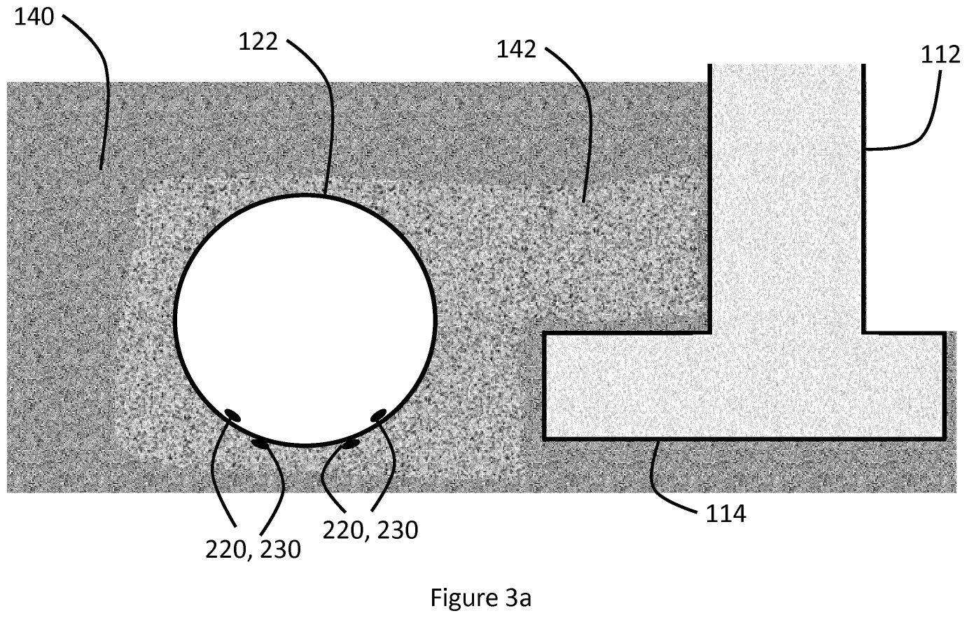

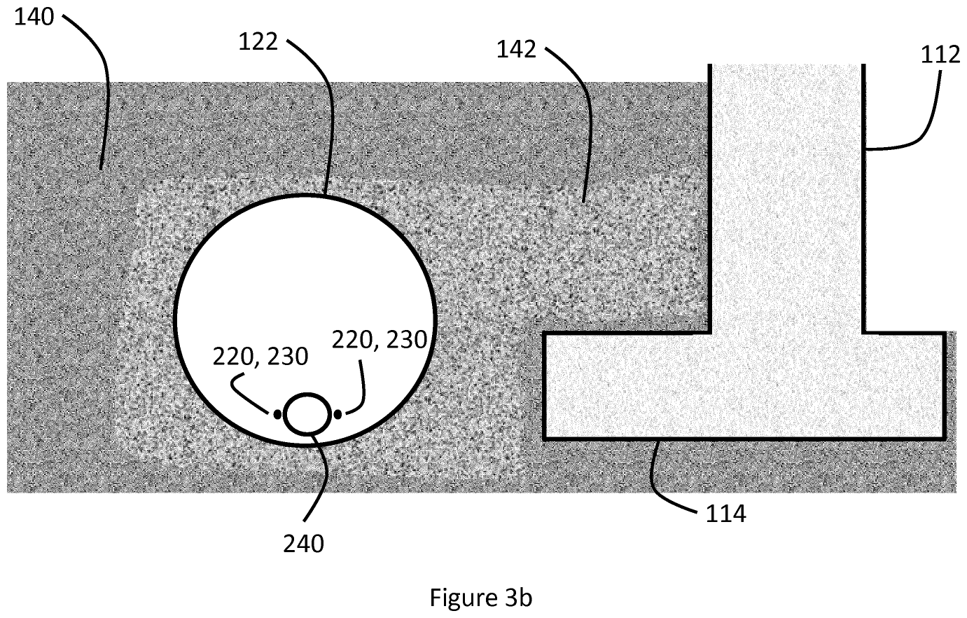

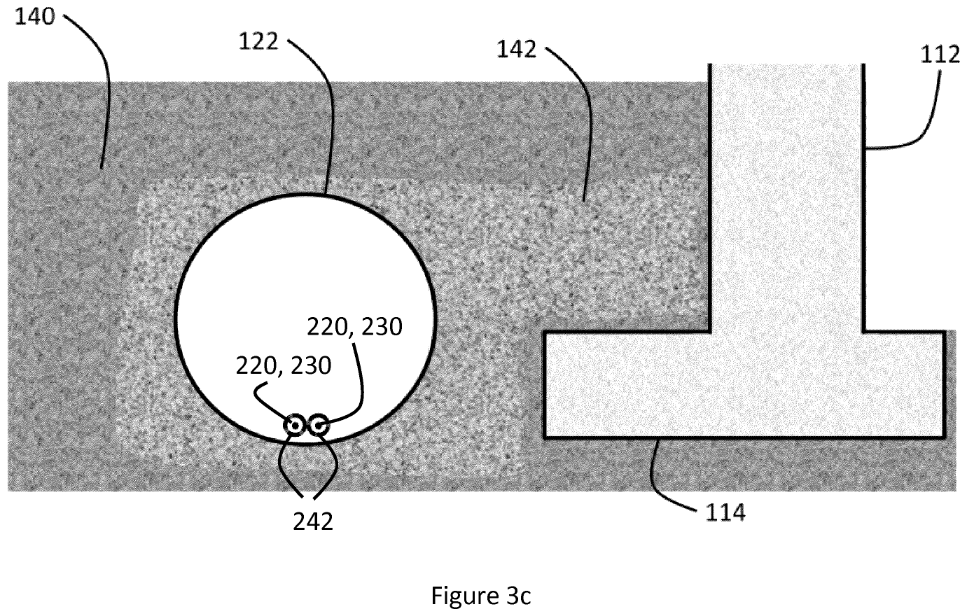

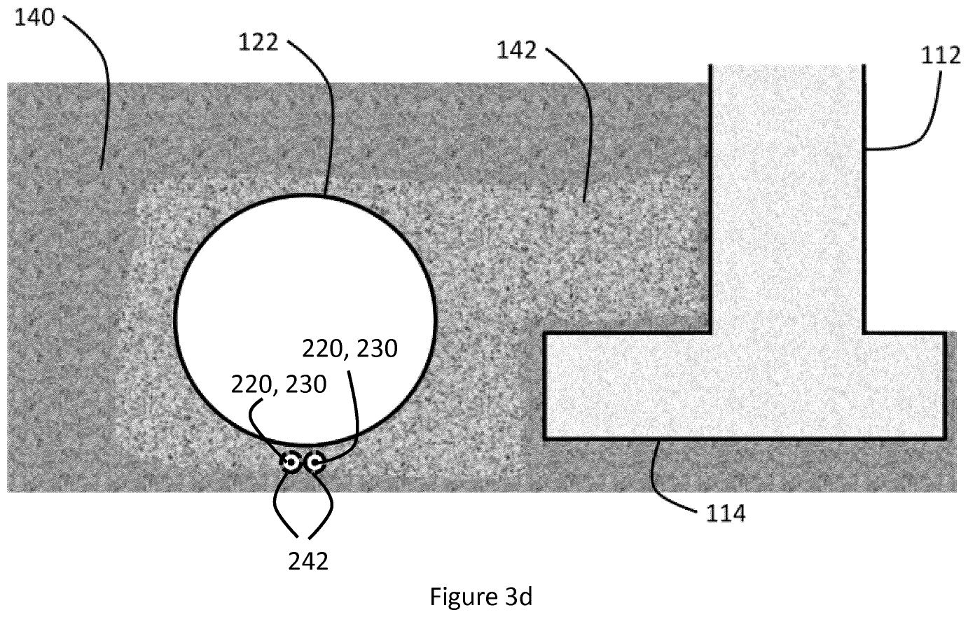

FIGS. 3a, 3b, 3c and 3d are schematic, cross-sectional elevation views of the conduit of the drainage system in its environment in accordance with an embodiment of the present technology. Each of FIGS. 3a-3d shows a wall 112 and a footing 114 of the foundation 110, and the drainage pipe 122. The drainage pipe 122 is buried in the ground 140 and contained within a gravel bed 142 disposed along the footing 114. In this context, the environment of the drainage system 120 comprises at least the gravel bed 142, the drainage pipe 122 and, to some extent, the ground 140 in proximity of the gravel bed 142. In another example, the environment of a conduit may be found within an agricultural field, within a sports field, within an airport runway, or within a playground.

Water may flow between various parts of the environment, although the water should normally flow from the ground 140 to the gravel bed 142 and further within the drainage pipe 122 toward the outlet 126 and the external collector 126, inasmuch as the drainage system 120 has been properly installed. FIGS. 3a-3d also show possible locations of the conductors 220 and 230. If the drainage pipe 122 is not perforated (at least in some portions thereof), the conductors 220 and 230 are located within the drainage pipe 112 as shown in FIGS. 3a and 3c. If the drainage pipe 112 is perforated, the conductors 220 and 230 may either be located within the drainage pipe 112, or on the outside, near its outer surface, in order to be in contact with water present in the environment. In the particular example of FIG. 3b, the conductors 220 and 230 may be attached to an elongated support member 240 adapted to be inserted in at least a section of the drainage pipe 122. FIGS. 3c and 3d each shows that the conductors 220 and 230 may be inserted in respective tubes 242, for example plastic tubes, the tubes 242 being configured to protect the conductors 220 and 230, particularly at the time of installation in the environment. In a non-limiting example, the conductors 220 and 230 may each have a 2 mm diameter and the tubes 242 may each have a 6.4 mm diameter. The tubes 242 are perforated at regular intervals so that the bacteria that may be present in the drainage pipe 122 is exposed to the electrical field generated by voltage applied to the conductors 220 and 230 substantially over the length of the conductors 220 and 230. The conductors 220 and 230 may be inserted in the tubes 242 prior to their installation in the environment, for example in a factory, the tube and conductor assembly being delivered in the form of compact cable rolls.

When the system 200 is intended to be installed on a new construction site, or as a replacement for an older drainage pipe 112 (i.e., the ground 140 is dug to expose the footing 114 of the foundation 110), the conductors 220 and 230 may easily be installed along all or at least a substantial part of the length of the drainage pipe 122. Therefore, in an embodiment, the conductors 220 and 230 may be mounted to the drainage pipe 122 prior to its installation along the footing 114.

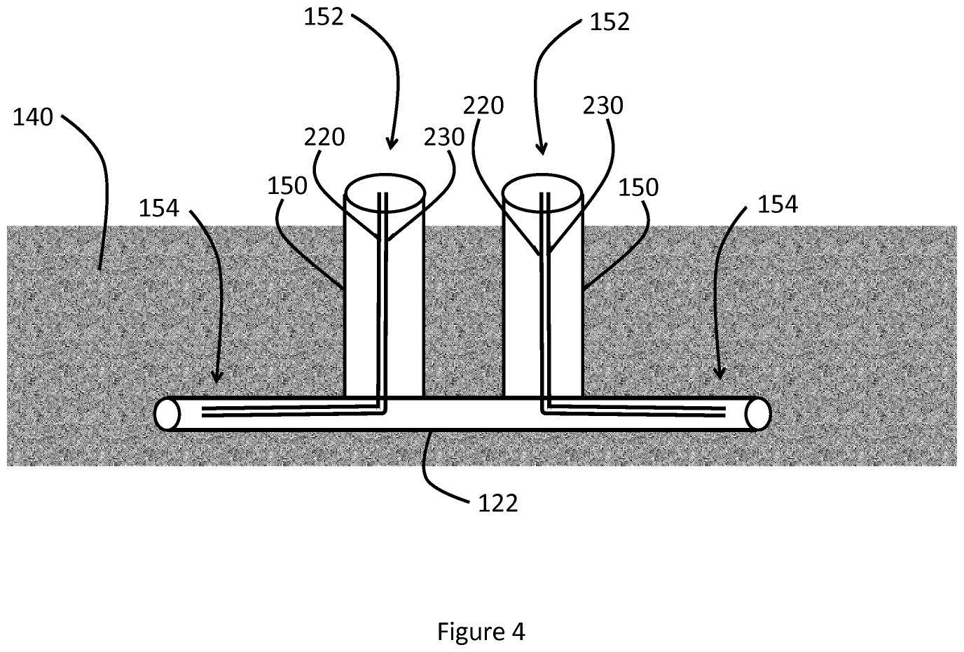

However, it may be inconvenient to have to replace the drainage pipe 112 in the case of an existing construction. To this end, FIG. 4 is a schematic, cross-sectional elevation view of a pair of access chimneys reaching the drainage system in accordance with an embodiment of the present technology. At least one access chimney 150 (two access chimneys 150 are shown) is installed by digging a hole in the ground 140 at a first position 152 and inserting a pipe in the hole, the pipe substantially reaching the drainage pipe 122. A pair of conductors 220 and 230 is inserted in each of the access chimneys 150 and is directed toward a second position 154 (connections of the conductors 220 and 230 to the voltage source 210 are not shown in order to simplify the illustration). A target section of the drainage pipe 122 is defined between the first and second positions 152 and 154. The voltage applied between the conductors 220 and 230 by the voltage source 210 control iron ochre proliferation within the target section of the drainage pipe 122. In a variant, two pairs of conductors may be installed in a single access chimney 150, one pair of conductors being directed toward the first position 154 and the other pair of conductors being directed toward the second position 154.

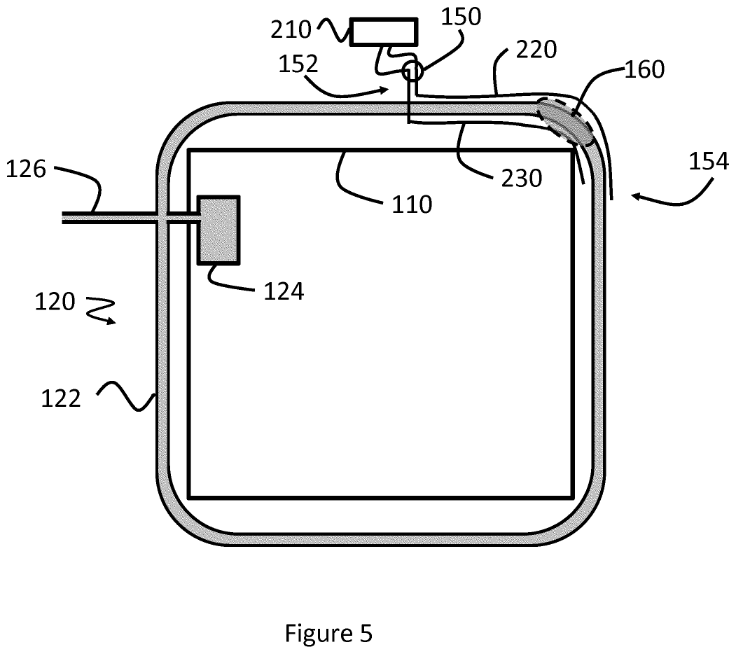

FIG. 5 is a schematic top plan view of the foundation of the house of FIG. 1, also showing a system for controlling iron ochre proliferation in a target section of the conduit of the drainage system in accordance with an embodiment of the present technology. A target section 160 of the drainage pipe 122, in which there is iron ochre proliferation, has been identified, for example by use of a camera inserted in the drainage pipe 122. First and second positions 152 and 154 are selected on both sides of the target section 160. An access chimney 150 is installed at the first position 152, and conductors 220 and 230, which are connected to the voltage source, and inserted via the access chimney 150 toward the drainage pipe 122 and are made to extend toward the second position 154.

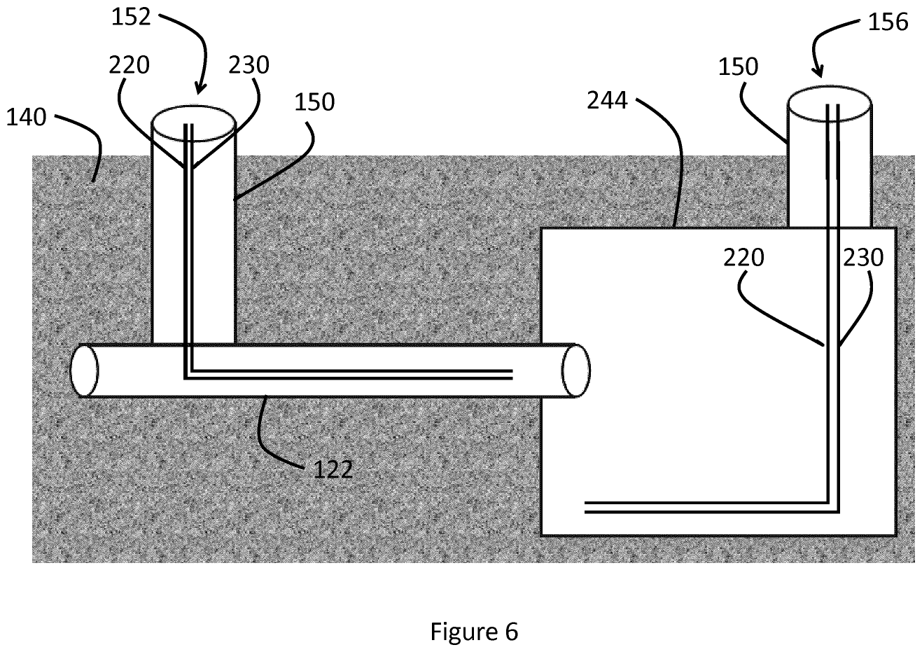

As a variant to the configuration of FIGS. 4 and 5, it may be desired to prevent accumulation of iron ochre in an underground retention reservoir. FIG. 6 is a schematic, cross-sectional elevation view of a pair of access chimneys 150, one of which reaches an underground retention reservoir in accordance with an embodiment of the present technology. In FIG. 6, an underground retention reservoir 244 is fluidly connected to the drainage pipe 122. One access chimney 150 is installed in the environment at a first position 152 in the manner described in FIG. 4, and another access chimney 150 is installed at a second position 156 so that it reaches the underground retention reservoir 244. A pair of conductors 220 and 230 is inserted in the access chimney 150 at the first position 152 and is directed within the drainage pipe 122 toward the underground retention reservoir 244. Another pair of conductors 220 and 230 is inserted in the access chimney 150 at the second position 156 and extends at least in part within the underground reservoir 244. Both pairs of conductors 220 and 230 are connected to the voltage source 210. The voltage applied between the conductors 220 and 230 by the voltage source 210 controls iron ochre proliferation in the drainage pipe 122 between the first position 152 and the underground retention reservoir 244 as well as within the underground reservoir 244.

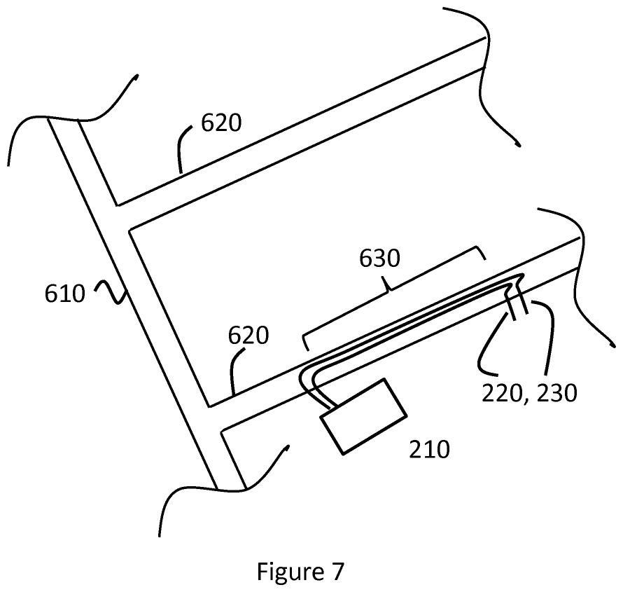

FIG. 7 is a schematic perspective view of a field having a drainage system and showing a system for controlling iron ochre proliferation in a conduit of the drainage system in accordance with an embodiment of the present technology. A field 600 may be an agricultural field, a sports field, a playground, a parking lot, an airport runway, or any other field or lot in which a drainage system is installed. The drainage system includes a collector conduit 610 and at least one drainage pipe 620 (two drainage pipes 620 are shown in the non-limiting example of FIG. 7). The drainage pipes 620 are made to collect groundwater within the field and to direct the groundwater toward the collector conduit 610.

A target section 630 of one of the drainage pipes 620, in which there is iron ochre proliferation, has been identified. Conductors 220 and 230 are installed along the drainage pipe 620, within the target section 630. The conductors 220 and 230 may be installed within the drainage pipe 620. If the drainage pipe 620 is perforated, one of both of the conductors 220 and 230 may alternatively be installed on or near an external surface of the drainage pipe 620, in the manner described hereinabove. Installation of the conductors 220 and 230 may be made, for example, by digging a trench in the field along the drainage pipe 620 along at least a length of the target section 630, and by filling the trench with the same material, possibly adding gravel along the drainage pipe 620.

The conductors 220 and 230 are connected to a voltage source, for example the voltage source 210, which is described hereinabove. Due to sequential and alternating application of voltage at reversing polarities on the conductors 220 and 230, iron ochre present in the target section 630 of the drainage pipe 620 is expected to gradually dissolve and leave the drainage pipe 620, which becomes unclogged. Of course, nothing in the example of FIG. 7 prevents mounting a pair of conductors 220 and 230 along each of the drainage pipes 620 and connecting the conductors 220 and 230 to the voltage source 210, in a preventive manner, before detecting any iron ochre proliferation.

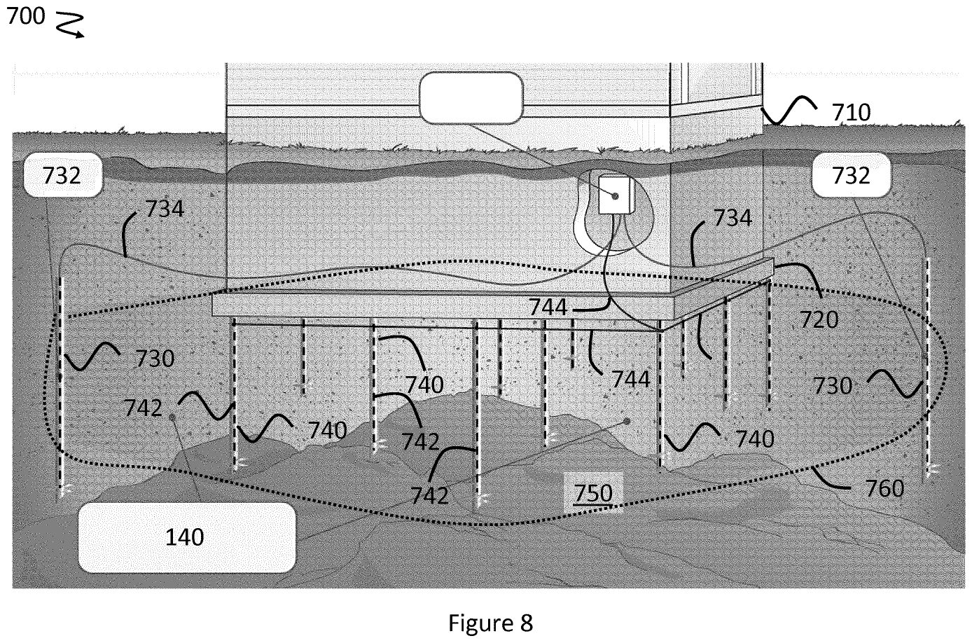

An alternate technique for controlling iron ochre proliferation in an inground volume is illustrated in FIG. 8, which is a perspective, cross-sectional view of a cathodic protection system in accordance with an embodiment of the present technology. This protection system 700 may be used as a standalone or in combination with any one of the above-described variants of the method and of the system 200 for controlling iron ochre proliferation in a conduit. FIG. 8 shows the system 700 and a building 710, for example a house, build atop a concrete slab 720 that is either on the ground 140 or buried in the ground 140. The system 700 comprises a first set of stakes 730 (only two are shown in order to simplify the illustration), for example helical piles such as manufactured by Techno Metal Post™ of Thetford Mines, QC, Canada, that are vertically installed at a distance of a few meters or a few tens of meters surrounding the periphery of the concrete slab 720. It is expected that the stakes 730 could be installed up to 200 meters from a site to be protected, the maximum distance varying in practice with a resistivity of the ground 140 in the area. A second set of similar stakes 740 are vertically installed on the periphery of the concrete slab 720. In cases where the concrete slab 720 has not yet been constructed, or in cases where it is possible to dig through the concrete slab 720, additional stakes 740 may be installed inside the periphery of the concrete slab 720. It should be understood that the stakes 730 and 740 may be installed in the ground at angles that are not perfectly vertical.

In cases where the drainage pipe 122 is installed (or planned to be installed) proximally to the concrete slab 720, the system 700 may protect further the drainage pipe 122 and its environment against iron ochre proliferation by installing the stakes 740 in close proximity to the drainage pipe 122. A volume 760 defines between a level of the concrete slab 720 and a level of dense soil material 750 (e.g., rock or dense earth) and within a perimeter formed by the stakes 730 generally defines the inground volume protected from iron ochre proliferation by the system 700.

Thin rods 732 and 742 of conductive material have been inserted in each of the stakes 730 and 740, respectively. Without limitation, the rods 732 and 742 may be made of the same or equivalent material as that of the conductors 220 and 230. Owing to their insertion in the vertical stakes 730 and 740, the rods 732 and 734 are vertical rods 732 and 742 when installed. Installing the rods 732 and 734 in other orientations is also contemplated.

The system 700 also comprises the voltage source 210, or an equivalent voltage source, which is installed in any convenient location within the building 710 or in proximity to the concrete slab 720. The voltage source 210 is electrically connected to each of the rods 732 via a set of wires 734 and to each of the rods 742 via another set of wires 744. The set of wires 744 reach the rods 742 that are on the periphery of the concrete slab 720 as well any of the rods 742 that may be inserted in stakes 740 located inside the periphery of the concrete slab 720. As a result, the rods 732 share a same polarity, whether on or inside the periphery of the concrete slab 720. The wires 734 and 744 are low-voltage wires that are adapted to be inserted into the ground 140.

In an embodiment, the voltage source 210 applies a continuous voltage, without inversion, to the rods 732 and 742. A positive voltage is applied to the rods 732, that are therefore anodes, while a negative voltage is applied to the rods 734, that are therefore cathodes. Current flows within the ground from the rods 732 (anodes) toward the rods 734 (cathodes) that are positioned on the periphery of the slab 720, some of the rods 734 possibly being positioned underneath the slab 720. This causes the ground volume underneath the concrete slab 720 to be polarized so that limestone and magnesium precipitate underneath the concrete slab 720. Bacteria that cause iron ochre proliferation cannot survive without magnesium. Accumulation of calcite (i.e., calcium carbonate) in the ground in the area between the rods 734 is expected to increase its bearing capacity.

In another embodiment of the system 700, the voltage source 210 may inverse the polarities applied on the rods 732 and 742 at regular intervals, so that the rods 732 become anodes and cathodes at the same time as the rods 742 become cathodes and anodes. The sequence may be repeated continuously. The same technical effects described hereinabove in relation to the system 200 and the environment of the drainage pipe 122 may then be reproduced by the system 700 within the volume 760.

The system 700 may also be employed to control iron ochre proliferation in a ground volume defined by a protected surface other than the concrete slab 720, for example and without limitation, within a volume defined underneath a parking lot, a tennis court, a football field, an agricultural field, an airport runway, and the like.

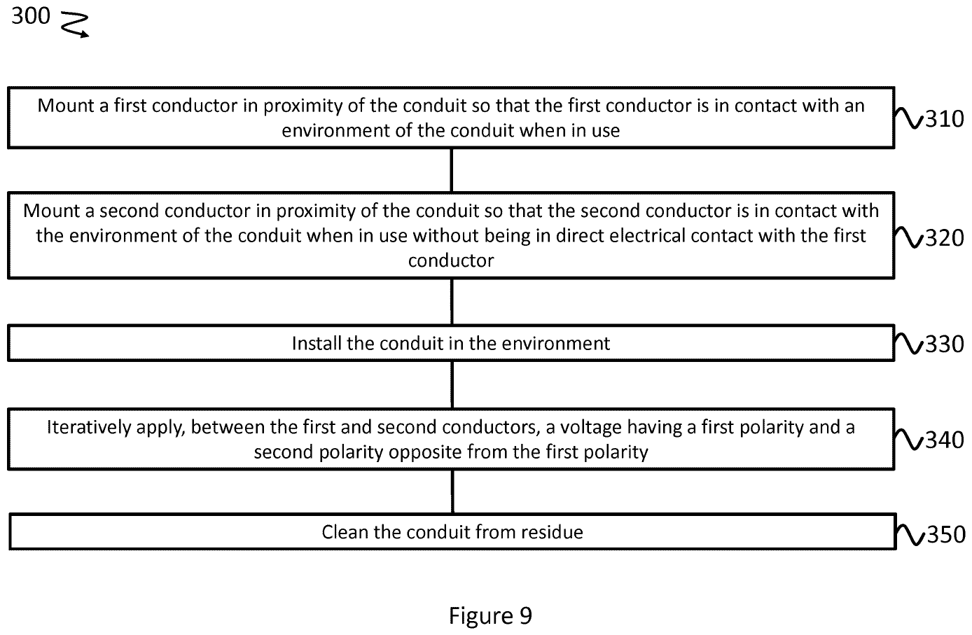

FIG. 9 is a sequence diagram showing operations of a method for controlling iron ochre proliferation in a conduit in accordance with an embodiment of the present technology. Operations of a sequence 300 may, for example and without limitation, be executed when installing the system 200 on a new construction site, or in a new trench dug in an agricultural field, in a sports field, in a playground, in an airport runway, and the like.

At operation 310, a first conductor 220 is mounted in proximity of the conduit, for example the drainage pipe 122, so that the first conductor is in contact with an environment of the conduit when in use. At operation 320, a second conductor 230 is mounted in proximity of the conduit so that the second conductor 230 is in contact with the environment of the conduit when in use. The first and second conductors 220, 230 are mounted so that there is no in direct electrical contact therebetween. If the conduit is perforated, one or both of the first and second conductors may selectively be mounted within the conduit or near an outer surface of the conduit. If the conduit is not perforated (or not perforated in some sections thereof), then each of the first and second conductors is mounted within the conduit (at least in the non-perforated sections).

The conduit is installed in the environment at operation 330. It should be noted that, depending on a choice of the manufacturer of the conduit, the conductors 220 and 230 may be attached to the conduit at the time of manufacturing. Otherwise, the installer may opt to mount the conductors 220 and 230 to the conduit before or after its installation in the environment, at operation 330.

Regardless, after operation 330, a voltage having a first polarity and a second polarity opposite from the first polarity is iteratively applied between the first and second conductors at operation 340. Without limitation, the voltage may be a direct current (DC) voltage having a magnitude between 7 and 8 volts, and the voltage may change (i.e., alternate) between the first and second polarities are a rate of once every 20 minutes or faster. Bacteria that might otherwise cause iron ochre proliferation in the conduit are expected to be killed by the application of the voltage between the conductors 220 and 230. In an embodiment, the magnitude of the voltage may vary over time, being for example increased in order to account for the eventual acclimatization of the bacteria to the voltage applied in the environment. Changes to the magnitude of the voltage may take place, for example and without limitation, after several months of operation of the system 200.

While executing the sequence 300 is expected to significantly reduce future accumulation of iron ochre in the drainage pipe 122, residue from iron ochre formation or from other sources may be present in the drainage pipe 122 after an extended period, for example after a few months. Optionally, operation 350 for cleaning the drainage pipe 122 from traces of iron ochre and/or other residue may be performed at regular intervals, for example once or twice a year. Mechanical cleaning methods using water jets (not shown), or a motorized brush (not shown), may be used to this end. Operation 350 may be triggered manually or automatically.

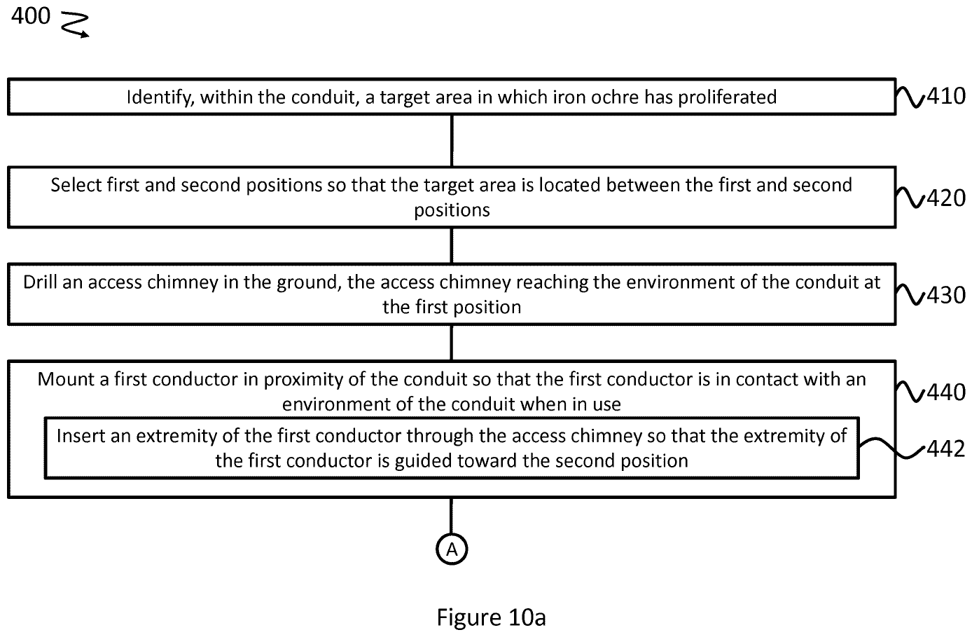

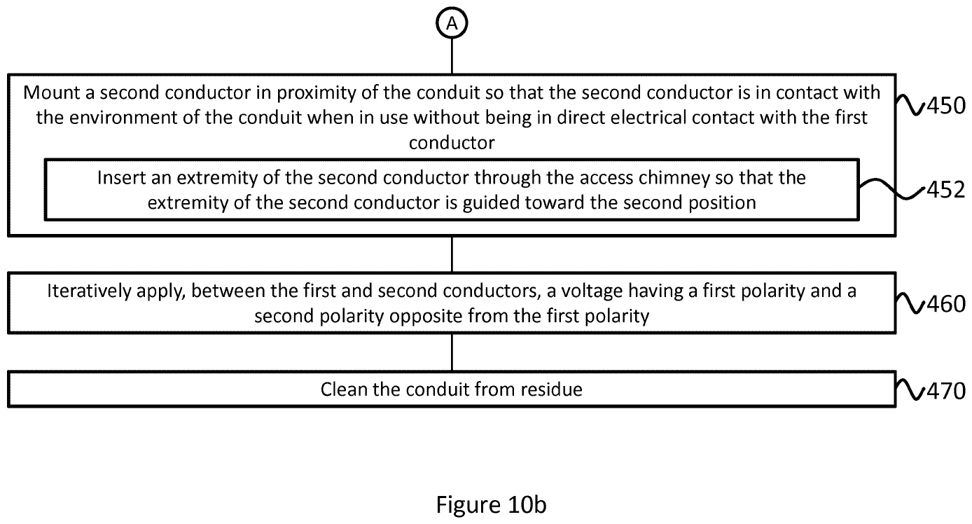

FIGS. 10a and 10b are a sequence diagram showing operations of a method for controlling iron ochre proliferation in a conduit having been installed in an environment in accordance with an embodiment of the present technology. Operations of a sequence 400 may, for example and without limitation, be executed when installing the system 200 on an existing site in which it may be difficult to have complete access to the surface of the conduit, for example the surface of the drainage pipe 122.

At operation 410, a target section may be identified within the drainage pipe 122 in which iron ochre has proliferated. This identification may be performed using any known technique used for locating a blockage in an ordinary pipe. First and second positions along the drainage pipe 122 may be selected, at operation 420, so that the target section is located between the first and second positions. At operation 430, an access chimney 150 may be drilled in the ground, the first access chimney 150 reaching the environment of the drainage pipe 122 at the first position. A plurality of access chimneys 150 may be drilled if appropriate.

At operation 440, a first conductor 220 is mounted in proximity of the drainage pipe 122 so that the first conductor 220 is in contact with an environment of the drainage pipe 122 when in use. Operation 440 may comprise sub-operation 442, in which an extremity of the first conductor 220 is inserted through the access chimney 150, if operation 430 has been performed, so that the extremity of the first conductor 220 is guided toward the second position; pairs of conductors 220 and 230 may be inserted in each access chimney 150 among a plurality of access chimneys 150 having been drilled at operation 430.

Continuing with FIG. 10b, at operation 450, a second conductor 230 is mounted in proximity of the drainage pipe 122 so that the second conductor 230 is in contact with the environment of the drainage pipe 122 when in use, without being in direct electrical contact with the first conductor 220. Operation 450 may comprise sub-operation 452, in which an extremity of the second conductor 230 is inserted through the access chimney 150 so that the extremity of the second conductor 230 is guided toward the second position.

After operations 440 and 450, a voltage having a first polarity and a second polarity opposite from the first polarity is iteratively applied, between the first and second conductors, at operation 460. As expressed hereinabove, the magnitude of the voltage may be configurable, for example being increased over time in order to account for the eventual acclimatization of the bacteria to the voltage applied in the environment.

An operation 470 for cleaning traces or iron ochre or other type or residue may take place. As in the case of operation 350 (FIG. 9), operation 350 may be triggered manually or automatically, using any suitable mechanical cleaning method. Operation 470 may be executed at any time in the sequence 400, including for example and without limitation, immediately after operation 410 when the target area has been identified within the drainage pipe 122. If an access chimney 150 has been drilled at operation 430, the drainage pipe 122 may be accessed via the access chimney 150 for purposes of cleaning the drainage pipe 122.

The same operation 470 may further be applied at regular intervals, in the sequence 400, as in the case of the sequence 300 (FIG. 9).

Operation 410 may identify more than one target area in which iron ochre has proliferated. As such, operation 420 may identify additional pairs of positions, each pair including respective first and second positions selected to be on both sides of a respective target area. Additional access chimneys 150 may be drilled at operation 430, one access chimney 150 being drilled at each respective first position. In the event that a plurality of access chimneys 150 have been drilled, operation 470 may be executed at least once via each access chimney 150. Additional pairs of conductors 220, 230 may be mounted in proximity of the drainage pipe 122 at operations 440 and 450, for example being inserted in the additional access chimneys 150 at sub-operations 442 and 452. A plurality of distinct sections of the drainage pipe 122 may each be mated with a corresponding pair including some length of each of the conductors 220 and 230. The pairs of conductors 220, 230 may be connected to the voltage source 210 in parallel, so that the voltage is iteratively applied between opposite conductors of each of the one or more pairs of additional conductors at operation 460.

In the sequence 400, as in the case of the sequence 300, each of the conductors 220 and 230 may be mounted within the drainage pipe 122. One or both of the conductors 220 and 230 may be mounted near the outer surface of the drainage pipe 122, provided that the drainage pipe 122 is perforated and that this is allowed by operational conditions on the site. In operation, the system 200 installed using the sequence 400 may use the same voltage range and/or alternate the voltage polarities at the same rate.

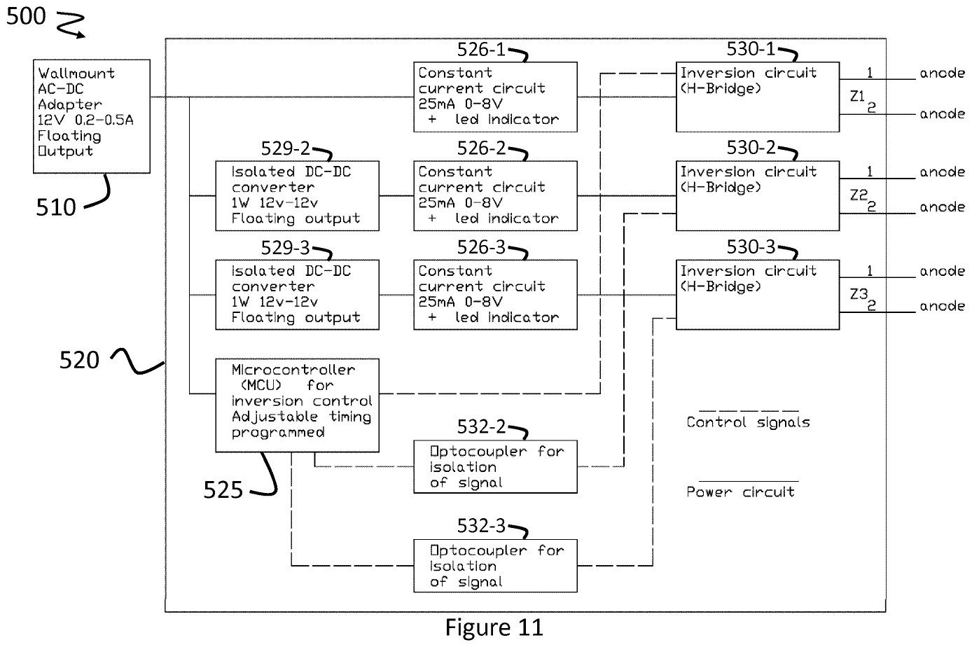

FIG. 11 is a block diagram of an electronic control system 500 for controlling iron ochre proliferation in a conduit of the drainage system in accordance with an embodiment of the present technology. The electronic control system 500 comprises an AC to DC converter 510 that can be connected to a conventional alternative current source as those found, for example, in any ordinary household. The AC to DC converter 510 provides a fairly low DC voltage output at a first polarity, for example and without limitation +12V with a 0.2 to 0.5 amperes capacity. This voltage is applied to various components of a circuit 520, which may be mounted in a plastic container or in another enclosure. The circuit 520 can iteratively apply the voltage at the first and second polarities to pairs of conductors such as the conductors 220 and 230 (FIG. 2) in at least one zone. The circuit 520 as illustrated can apply the voltage to pairs of conductors in three separate zones, for example a first zone Z1, a second zone Z2, and a third zone Z3, which are electrically isolated from one another.

In the circuit 520, an inversion controller 525 is used to apply control signals to circuitry for each of the zones. The inversion controller 525 can be a programmable controller, for example and without limitation a PIC10F322 controller from Microchip Technology Inc. of Chandler, Arizona.

To serve the first zone Z1, the circuit 520 comprises a constant current circuit adapter 526-1 that may include a led indicator. The circuit adapter 526-1 may regulate a magnitude of the voltage so that it remains close to a predetermined value, for example 7 or 8 volts, also regulating a current level so that it remains close to a predetermined value, for example 25 milliamperes. The circuit adapter 526-1 is connected to a polarity inverter 530-1. As expressed hereinabove, the magnitude of the voltage may be configurable, for example being increased over time, in order to account for the eventual acclimatization of the bacteria to the voltage applied in the environment.

The polarity inverter 530-1 selectively alters the polarity of the voltage from the circuit adapter 526-1 between its outputs 1 and 2 according to polarity inversion commands received from the inversion controller 525. The conductors 220 and 230 being respectively connected to the outputs 1 and 2, the application of the voltage in alternating polarities helps in controlling iron ochre proliferation in the first zone Z1.

The electronic control system 500 may be used as a part of the system 200 for controlling iron ochre proliferation in a plurality of zones, for example in the second zone Z2 and in the third zone Z3. To this end, the circuit 520 may include, for each of the zones Z2 and Z3, an isolated DC to DC converter 529-2 or 529-3 used for isolating corresponding circuit adapters 526-2 and 526-3 and corresponding polarity inverters 530-2 and 530-3 from the remainder of the circuit 520. Each of the DC-to-DC converters 529-2 and 529-3 may for example have a 1-watt capacity. The circuit adapters 526-2 and 526-3 are generally identical to the circuit adapter 526-1, and the polarity inverters 530-2 and 530-3 are generally identical to the polarity inverter 530-1. Polarity inversion commands from the inversion controller 525 may be transmitted to the polarity inverters 530-2 and 530-3 via optocouplers 532-2 and 532-3 in order to ensure isolation of control signals between the various zones Z1, Z2 and Z3. An additional pair of conductors such as the conductors 220 and 230 may be connected to the outputs 1 and 2 of each of the polarity inverters 530-2 and 530-3.

Although the electronic control system 500 as illustrated on FIG. 11 is configured to serve three zones Z1, Z2 and Z3 with corresponding pairs of conductors, it is contemplated that the electronic control system 500 could serve fewer or more zones.

The same or a similar electronic control system 500, or a variant thereof, may also be used as a part of the system 700. In embodiments in which the voltage applied to the rods 732 and 742 (FIG. 8) is intended to be inverted at regular intervals, the volume 760 may simply form one of the zones Z1, Z2 and Z3, the wires 734 and 744 being attached to one of the polarity inverters 530-1, 530-2 or 530-3. In other embodiments in which the voltage applied to the rods 732 and 742 is constant, the wires 734 and 744 may be connected directed to one of the circuit adapters 526-1, 526-2 or 526-3, ensuring that the wires 734 are connected to a positive output thereof. The magnitude of the voltage applied between the rods 732 and 742 may be the same as, or different from, the magnitude of the voltage applied to the conductors 220 and 230. Actual voltage and current values may differ in the case of the system 700, at least in part as a function of the size of the area to be protected and of the nature of the ground in the area. For example and without limitation, the voltage applied between the rods 732 and 742 may reach 20 volts, causing a current reaching 0.5 to 2.5 amperes.

While the above-described implementations have been described and shown with reference to particular steps performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1.-13. (canceled)

14. A method for controlling iron ochre proliferation in a conduit, the method comprising:
mounting a first conductor in proximity of the conduit at a first conductor position,
in the first conductor position, the first conductor extending along a length of the conduit and being in contact with water present in the environment of the conduit when in use;
mounting a second conductor in proximity of the conduit at a second conductor position,
in the second conductor position, the second conductor extending along the length of the conduit and being in contact with water present in the environment of the conduit when in use,
at least a target section within the conduit in which iron ochre proliferation is to be controlled being disposed between the first conductor position and the second conductor position,
the second conductor not being in direct electrical contact with the first conductor; and
repeatedly applying a sequence of a first voltage and a second voltage between the first and second conductors,
at the first voltage, a potential of the first conductor being higher than a potential of the second conductor, and
at the second voltage, the potential of the first conductor being lower than the potential of the second conductor.

15. The method of claim 14, further comprising installing the conduit in the environment

16. The method of claim 15, wherein the first and second conductors are attached to the conduit prior to installing the conduit in the environment.

17. The method of claim 14, wherein one or both of the first and second conductors is made of mixed metal oxide titanium.

18. (canceled)

19. (canceled)

20. The method of claim 14, wherein:
in the first conductor position, the first conductor is one of:
inside the conduit; or
near an outer surface of the conduit; and
in the second conductor position, the second conductor is one of:
inside the conduit; or
near the outer surface of the conduit.

21. The method of claim 14, wherein the conduit is perforated and wherein each of the first and second conductors is mounted within the conduit or near an outer surface of the conduit.

22. The method of claim 21, wherein:
the first conductor is inserted within a first tube, the first tube being perforated at regular intervals;
the second conductor is inserted within a second tube, the second tube being perforated at regular intervals; and
the first and second tubes are mounted within the conduit or near an outer surface of the conduit.

23. The method of claim 14, wherein the conduit is not perforated and wherein each of the first and second conductors is mounted within the conduit.

24. The method of claim 23, wherein:
the first conductor is inserted within a first tube, the first tube being perforated at regular intervals;
the second conductor is inserted within a second tube, the second tube being perforated at regular intervals; and
the first and second tubes are mounted within the conduit.

25. (canceled)

26. (canceled)

27. The method of claim 14, further comprising:
initially applying the first and second voltages at a first magnitude; and
later applying the first and second voltages at a second magnitude different from the first magnitude.

28.-33. (canceled)

34. A system for controlling iron ochre proliferation in a conduit, the system comprising:
a first conductor configured for being mounted in proximity of the conduit at a first conductor position,
in the first conductor position, the first conductor extending along a length of the conduit and being in contact with water present in an environment of the conduit when in use;
a second conductor configured for being mounted in proximity of the conduit at a second conductor position,
in the second conductor position, the second conductor extending along the length of the conduit and being in contact with water present in the environment of the conduit when in use,
at least a target section within the conduit in which iron ochre proliferation is to be controlled being disposed between the first conductor position and the second conductor position,
the second conductor not being in direct electrical contact with the first conductor; and
a voltage source electrically connected to the first and second conductors and configured for repeatedly applying a sequence of a first voltage and a second voltage between the first and second conductors,
at the first voltage, a potential of the first conductor being higher than a potential of the second conductor, and
at the second voltage, the potential of the first conductor being lower than the potential of the second conductor.

35. The system of claim 34, further comprising the conduit.

36. (canceled)

37. The system of claim 14, wherein:
in the first conductor position, the first conductor is one of:
inside the conduit; or
near an outer surface of the conduit; and
in the second conductor position, the second conductor is one of:
inside the conduit; or
near the outer surface of the conduit.

38. The system of claim 14, wherein the conduit is perforated and wherein each of the first and second conductors is configured to be mounted within the conduit or near an outer surface of the conduit.

39. The system of claim 38, wherein:
the first conductor is inserted within a first tube, the first tube being perforated at regular intervals;
the second conductor is inserted within a second tube, the second tube being perforated at regular intervals; and
the first and second tubes are mounted within the conduit or near an outer surface of the conduit.

40. The system of claim 34, wherein the conduit is not perforated and wherein each of the first and second conductors is configured to be mounted within the conduit.

41. The system of claim 40, wherein:
the first conductor is inserted within a first tube, the first tube being perforated at regular intervals;
the second conductor is inserted within a second tube, the second tube being perforated at regular intervals; and
the first and second tubes are mounted within the conduit.

42.-44. (canceled)

45. The system of claim 34, wherein one or both of the first and second conductors is made of mixed metal oxide titanium.

46. (canceled)

47. (canceled)

48. The system of claim 34, wherein the voltage source comprises:
a polarity inverter configured to receive the first voltage and to apply the first voltage and at the second voltage between the first and second conductors; and
a controller configured to:
receive the first voltage from an AC to DC converter;
provide the first voltage to the polarity inverter; and
provide polarity inversion commands to the polarity inverter.

49. (canceled)

50. The system of claim 48, wherein the voltage source further comprises:
one or more isolation circuits configured to receive the first voltage from the AC to DC converter; and
one or more additional polarity inverters, each of the one or more additional polarity inverters being configured to:
receive the first voltage from a corresponding one of the one or more isolation circuits;
receive polarity inversion commands from the controller; and
apply the first voltage and at the second voltage between a corresponding pair of additional conductors.

51.-59. (canceled)
